(19) United States
(12) Patent Application Publication
(10) Pub. No.: US 2025/0033491 A1
(43) Pub. Date: Jan. 30, 2025

(54) TRACTION BATTERY CHARGING

(71) Applicant: FORD GLOBAL TECHNOLOGIES, LLC, Dearborn, MI (US)

(72) Inventors: Brendan F. DIAMOND, Grosse Pointe, MI (US); Jonathan HAIR, Northville, MI (US); Matthew PENNE, Pierce, NE (US); Keith WESTON, Canton, MI (US); David Michael RUSSELL, Ann Arbor, MI (US)

(21) Appl. No.: 18/226,996

(22) Filed: Jul. 27, 2023

(51) Int. Cl. B60L 53/10; B60L 53/62

(52) U.S. Cl. CPC B60L 53/11; B60L 53/62; B60L 2250/00

(57) ABSTRACT

A controller, responsive to a request to DC fast charge a traction battery at a charge station that offers a plurality of DC fast charge rates each with a cost per unit time that increases as the rate increases, generates output, only for each of the rates that correspond to an aging parameter for the traction battery that is less than a threshold value, indicating a cost to charge the traction battery at the rate.

### TECHNICAL FIELD

The present disclosure relates to strategies for charging electric vehicles.

### BACKGROUND

Electric vehicles are provided with one or more traction batteries for propulsion. The traction batteries may be recharged by a charger.

### SUMMARY

A vehicle includes a traction battery and a controller. The controller, responsive to a request to DC fast charge a traction battery at a charge station that offers a plurality of DC fast charge rates each with a cost per unit time that increases as the rate increases, generates output, only for each of the rates that correspond to an aging parameter for the traction battery that is less than a threshold value, indicating a cost to charge the traction battery at the rate, and charges the traction battery at a selected one of the rates.

A method includes, after receiving a request to DC fast charge a traction battery at a charge station that offers a plurality of DC fast charge rates each with a cost per unit time that increases as the rate increases, charging the traction battery at one of the rates automatically selected according to a total cost that includes portions representing a power cost for the charge, a user's time cost for the charge, and a traction battery aging cost for the charge such that the total cost is less than a threshold cost.

A vehicle control system includes a controller that charges a traction battery at one of a plurality of DC fast charge rates selected such that the one corresponds to an aging parameter for the traction battery, that is based on a duration of the charge, less than a threshold value.

### BRIEF DESCRIPTION OF THE DRAWINGS

FIG. 1 is a diagram of an electrified vehicle illustrating drivetrain and energy storage components including an electric machine.

FIG. 2 is a block topology of a vehicle charging system.

FIG. 3 is a flow diagram of a process for charging an electric vehicle.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system and method for charging an electric vehicle. Conventionally, a total price for charging an electric vehicle may be determined by a total amount of electric energy received by the vehicle. With the introduction of high power DC chargers, the utility companies may set the pricing rate based on maximum charging power over time. For instance, 150 kW DC fast charging power may correspond to $0.99/min whereas 75 kW DC fast charging power may correspond to only $0.25/min. In a variable power charging process, the charge may adjust the charging power based on real time feedback from the vehicle battery. The charging process may start with a high charging power when the battery state of charge (SOC) is low and gradually reduce the charging power as the SOC increases. However, the pricing rate corresponding to the maximum charging power may be applied throughout the entire charging process. Continuing with the current example, if the charging process starts with 150 kW charging power, the pricing rate of the present charging process will be set to $0.99/min throughout the entire process even when charging power is subsequently reduced to 75 kW. In other words, the pricing rate for the charging process is determined by the highest charging power despite the fact that highest charging power is utilized only at the beginning of the process. The present disclosure proposes a system for charging the vehicle while allowing the user to save.

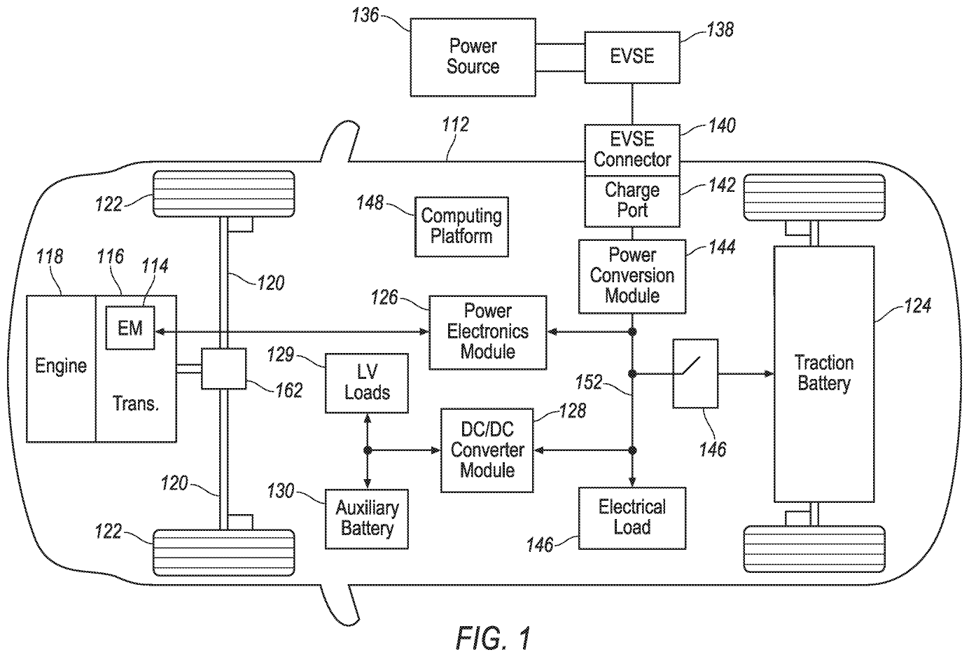

FIG. 1 depicts an electrified vehicle 112 that may be referred to as a plug-in hybrid-electric vehicle (PHEV), a battery electric vehicle (BEV), and/or full hybrid electric vehicle (FHEV). A plug-in hybrid-electric vehicle 112 may comprise one or more electric machines 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 can provide propulsion and braking capability when the engine 118 is turned on or off. The electric machines 114 may also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. The electrified vehicle 112 may also be a BEV. In a BEV configuration, the engine 118 may not be present.

A traction battery or battery pack 124 stores energy that can be used by the electric machines 114. The vehicle battery pack 124 may provide a high voltage direct current (DC) output. The traction battery 124 may be electrically coupled to one or more power electronics modules 126 (such as a traction inverter). The power electronics module 126 is also electrically coupled to the electric machines 114 and provides the ability to bi-directionally transfer energy between the traction battery 124 and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124.

The vehicle 112 may include a variable-voltage converter (VVC) (not shown) electrically coupled between the traction battery 124 and the power electronics module 126. The VVC may be a DC/DC boost converter configured to increase or boost the voltage provided by the traction battery 124. By increasing the voltage, current requirements may be decreased leading to a reduction in wiring size for the power electronics module 126 and the electric machines 114. Further, the electric machines 114 may be operated with better efficiency and lower losses.

In addition to providing energy for propulsion, the traction battery 124 may provide energy for other vehicle electrical systems. The vehicle 112 may include a DC/DC converter module 128 that converts the high voltage DC output of the traction battery 124 to a low voltage DC supply that is compatible with low-voltage vehicle loads 129. An output of the DC/DC converter module 128 may be electrically coupled to an auxiliary battery 130 (e.g., 12V battery) for charging the auxiliary battery 130. The low-voltage systems may be electrically coupled to the auxiliary battery 130.

The electrified vehicle 112 may be configured to recharge the traction battery 124 from an external power source 136. The external power source 136 may be a connection to an electrical outlet. The external power source 136 may be electrically coupled to a charger or electric vehicle supply equipment (EVSE) 138. The external power source 136 may be an electrical power distribution network or grid as provided by an electric utility company. The EVSE 138 may provide circuitry and controls to manage the transfer of energy between the power source 136 and the vehicle 112. The external power source 136 may provide DC or AC electric power to the EVSE 138. The EVSE 138 may have a charge connector 140 for plugging into a charge port 142 of the vehicle 112. The charge port 142 may be any type of port configured to transfer power from the EVSE 138 to the vehicle 112. The charge port 142 may be electrically coupled to a charger or on-board power conversion module 144. The power conversion module 144 may condition the power supplied from the EVSE 138 to provide the proper voltage and current levels to the traction battery 124. The power conversion module 144 may interface with the EVSE 138 to coordinate the delivery of power to the vehicle 112. The EVSE 138 may output a DC fast charging current to charge the traction battery 124 via the power conversion module 144. The EVSE 138 may adjust the charging power by varying the current (or voltage) output. The EVSE connector 140 may have pins that mate with corresponding recesses of the charge port 142. Alternatively, various components described as being electrically coupled or connected may transfer power using a wireless inductive coupling. Additionally, the charge port 142 may be configured to output DC electric power from the traction battery 124 through the power conversion module 144. One or more contactors 146 may isolate the traction battery 124 from other components when opened and connect the traction battery 124 to other components when closed.

Electronic modules/controllers in the vehicle 112 may communicate via one or more vehicle networks (to be described in detail below). The vehicle network may include a plurality of channels for communication. Channels of the vehicle network may include discrete connections between modules and may include power signals from the auxiliary battery 130. Different signals may be transferred over different channels of the vehicle network. For example, video signals may be transferred over a high-speed channel while control signals may be transferred over a low speed channel. The vehicle network may include any hardware and software components that aid in transferring signals and data between modules. A computing platform 148 may be present to perform and coordinate various operations of the vehicle 112.

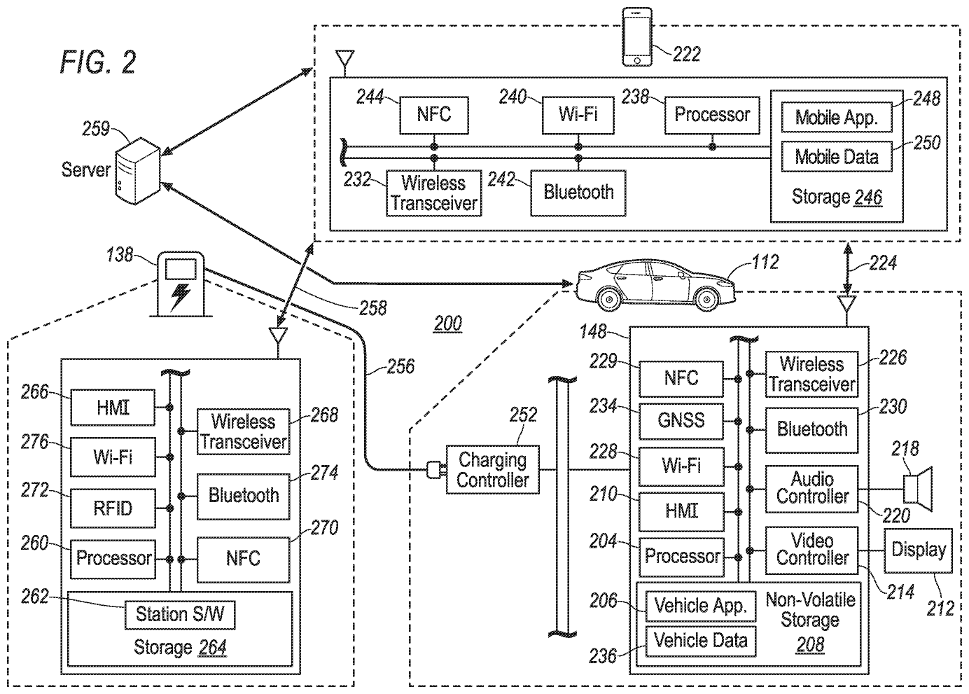

FIG. 2 is a block topology 200 of the vehicle charging system. A computing platform 148 of the vehicle 112 may include one or more processors 204 configured to perform instructions, commands, and other routines in support of the processes described herein. For instance, the computing platform 148 may be configured to execute instructions of vehicle applications 206 to provide features such as communication, and charging controls. Such instructions and other data may be maintained in a non-volatile manner using a variety of types of computer-readable storage medium 208. The computer-readable medium 208 (also referred to as a processor-readable medium or storage) includes any non-transitory medium (tangible medium) that participates in providing instructions or other data that may be read by the processor 204 of the computing platform 148. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and SQL.

The computing platform 148 may be provided with various features allowing the vehicle occupants/users to interface with the computing platform 148. For example, the computing platform 104 may receive input from human-machine interface (HMI) controls 210 configured to provide for occupant interaction with the vehicle 112. As an example, the computing platform 148 may interface with one or more buttons (not shown) or other HMI controls (e.g., steering wheel audio buttons, a push-to-talk button, instrument panel controls, etc.) configured to invoke functions on the computing platform 148 as well as other components of the vehicle 112.

The computing platform 148 may also drive or otherwise communicate with one or more displays 212 configured to provide visual output to vehicle occupants by way of a video controller 214. In some cases, the display 212 may be a touch screen further configured to receive user touch input via the video controller 214, while in other cases the display 212 may be a display only, without touch input capabilities. The computing platform 104 may also drive or otherwise communicate with one or more speakers 218 configured to provide audio output to vehicle occupants by way of an audio controller 220.

The computing platform 148 may be configured to communicate with a mobile device 222 of the vehicle user via a wireless connection 224. The mobile device 222 may be any of various types of portable computing device, such as cellular phones, tablet computers, smart watches, laptop computers, portable music players, key fobs, or other devices capable of communication with the computing platform 148. In many examples, the computing platform 148 may include a wireless transceiver 226 in communication with a Wi-Fi controller 228, a near-field controller (NFC) 229, a Bluetooth controller 230, and other controllers such as a Zigbee transceiver, an IrDA transceiver, an RFID transceiver (not shown), and configured to communicate with a compatible wireless transceiver 232 of the mobile device 222. The computing platform 148 may be further provided with location services via a global navigation satellite system (GNSS) controller 234 configured to determine the location of the vehicle 112 and plan navigation routes. For instance, the GNSS controller 234 may be configured to support the global positioning system (GPS) as an example. The navigation software may be stored in the non-volatile storage 208 as a part of the vehicle applications 206. The map data used for route planning may be also stored in the non-volatile storage 208 as a part of vehicle data 236.

The mobile device 222 may be provided with a processor 238 configured to perform instructions, commands, and other routines in support of the processes such as calling, wireless communication, multi-media processing and digital authentication. The wireless transceiver 232 of the mobile device 222 may be in communication with a Wi-Fi controller 240, a Bluetooth controller 242, an NFC controller 244, and other controllers configured to communicate with the compatible wireless transceiver 226 of the computing platform 148. The mobile device 222 may be provided with a non-volatile storage 246 configured to store various software and data. For instance, the non-volatile storage 246 may store mobile applications 248 and mobile data 250 to enable various features of the mobile device 222.

The computing platform 148 may be further configured to communicate with a charging controller 252 via one or more in-vehicle networks 254. The in-vehicle network 254 may include, but is not limited to, one or more of a controller area network (CAN), an Ethernet network, an ultra-wide band (UWB), and a media-oriented system transport (MOST), as some examples.

The charging controller 252 of the vehicle 112 may be configured to control the charging of the vehicle battery 124. The charging controller 252 may be configured to communicate with the EVSE 138 (charger) to coordinate the vehicle charging via a charging cable 256 in support of data communications. Alternatively, the charging controller 252 may be configured to communicate with the EVSE 138 via a wireless connection (not shown). Additionally or alternatively, the system may be configured to communicate the vehicle information to the EVSE 138 using the mobile device 222 through a wireless connection 258 with or without the involvement of the vehicle charging controller 252. The vehicle 112 and the mobile device 222 may be further configured to communicate with a remote server 259 via the respective wireless transceiver to obtain various information.

The EVSE 138 may include one or more processors 260 configured to perform instructions, commands, and other routines in support of the processes described herein. As an example, the EVSE 138 may be configured to execute instructions of station software 262 stored in a storage 264 to provide functions such as activating/deactivating charging, price selection, processing payment, and wireless communication with various digital entities. The EVSE 138 may be provided with HMI controls 266 configured to provide interaction with the user.

The EVSE 138 may include a wireless transceiver 268 in communication with an NFC controller 270, a radio-frequency identification (RFID) controller 272, a Bluetooth controller 274 a Wi-Fi controller 276, and other controllers configured to communicate with compatible wireless transceiver 226 of the vehicle 112, and/or compatible wireless transceiver 232 of the mobile device 222.

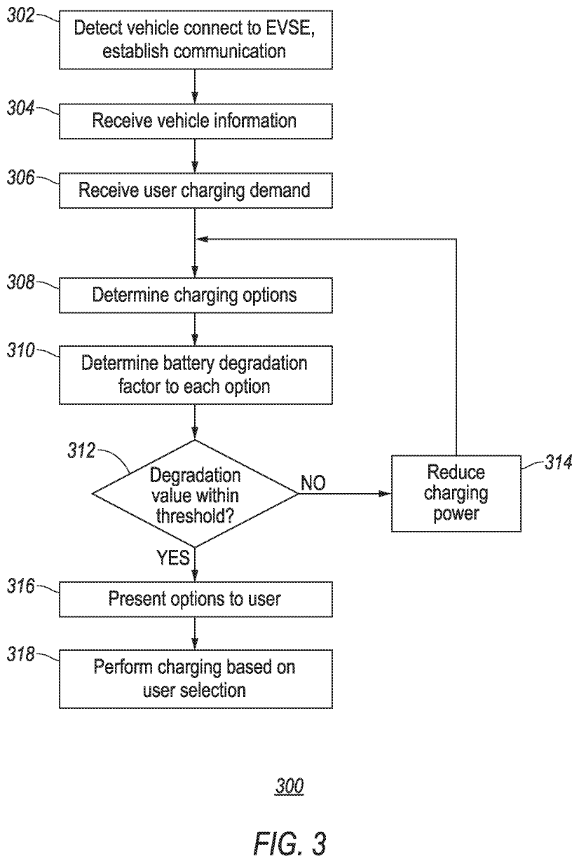

Referring to FIG. 3, an example flow diagram of a process 300 for charging the vehicle of one embodiment of the present disclosure is illustrated. The process 300 provides a method for more economically and flexibly charging the vehicle by allowing the vehicle user to customize the charging preferences while taking the battery aging caused by DC fast charging into account. With continuing reference to FIGS. 1 and 2, the process 300 may be individually or collectively implemented via one or more of the EVSE 138, the charging controller 252 of the vehicle 112, and/or the server 259. For simplicity, the following description will be made with reference to the EVSE 138. At operation 302, responsive to detecting the vehicle 112 is connected to the EVSE connector 140 via the charge port 142, the EVSE 138 establishes data communication with the vehicle 112 in preparation of the upcoming charging event. As discussed above, the charging cable 256 may be configured to support data communication protocols and therefore enables a wired communication between the EVSE 138 and the charging controller 252 of the vehicle 112. Additionally or alternatively, the data communication may be established between the EVSE 128 and the vehicle 112 via a wireless connection through the wireless transceivers 268, 226 of each respective device. Additionally or alternatively, the EVSE 138 may establish a wireless data communication with the mobile device 222 associated with the vehicle 112.

At operation 304, the EVSE 138 receives vehicle information via the data communication previously established. The vehicle information may include various information/data related to the vehicle 112 that may be used to evaluate the vehicle charging. For instance, the vehicle information may include a SOC of the traction battery 124 that may be used to determine the amount of energy the vehicle needs. The vehicle information may further include vehicle make/model and charging power configurations (e.g. charging power) that are supported by the vehicle 112 that may be used to determine one or more charging powers applicable to the vehicle 112. The vehicle information may further include battery health and temperature information of the traction battery 124 that may be used to adjust the charging power.

As discussed above, the present disclosure allows the vehicle user to customize the charging experience based on the user preference. At operation 306, the EVSE 138 receives a charging demand for the present charging event specified by the user. The charging demand may be received from the vehicle 112 and/or the mobile device 112 associated with the vehicle 112. The charging demand may specify a desired result for the charging event that is defined by the user. For instance, the charging demand may include a desired target SOC at the end of the charging event specified by the user. The charging demand may further include a maximum duration of the charging event that the user is willing to wait. The charging demand may further include a maximum budget that the user is willing to pay. For instance, the charging demand may include a target SOC of 80% (from the current 30%) with the maximum duration of 20 minutes and maximum budget of $20.

The charging demand may further include a battery aging threshold within which the battery aging caused by the current charging event is allowed. As discussed above, DC fast charging may cause the battery health to degrade due to the heat generated by the high current. The battery aging may be quantified in various manners. For instance, the battery aging may be quantified in the form of percentage of total battery capacity loss (e.g. 0.01% of maximum capacity per charge). Additionally or alternatively, the battery aging may be quantified in to form of monetary value that is calculated based on the amount of capacity loss. Continuing with the above example, if the total value of the traction battery 124 is defined as $10,000, a 0.01% of capacity loss may be converted into an equivalent of approximately $1.00 monetary devaluation of the traction battery 124. The battery aging (especially in the monetary devaluation form) may be taken into account as a part of the maximum price offered by the vehicle. For instance, the user pays $30 for the fast charging and $2.00 battery devaluation is caused during the fast charging, the actual total amount of expense associated with the fast charging event is $32 instead of $30. Therefore, the maximum budget of the user will be at least $32 for the present charging event to qualify.

At operation 308, the EVSE 138 determines the one or more candidate charging options using both the vehicle information and the charging demand previously received. Depending on the specific situation, more than one candidate charging options may be determined. Each candidate charging option may include a variety of characteristics associated with the planned charging event that qualifies the charging demand specified by the user. For instance, the charging option may include one or more charging powers at various stage of the charging event that satisfied both the time and budget requirements of the user. In general, the charging event may start with a higher charging power at the beginning of the charging event and gradually reduce the charging power depending on the anticipated and real time feedback from the traction battery 124 over the duration of the charging event. The variation of charging power may affect charging duration which in turn may result in different total price. In addition, the different charging powers may also cause different battery agings. At operation 310, the EVSE 138 determines the battery aging of each candidate charging option and associates the battery aging with the corresponding charging option. Therefore, each charging option may be associated with a price, a charging duration and a battery aging value (aging parameter). The battery aging may be determined and calculated by taking into account various factors. As a few non-limiting examples, the battery aging may be determined using factors such as an anticipated heat amount and/or temperature predicted using the charging powers and their corresponding duration. The battery aging may be further determined using a current and/or anticipated ambient temperature during the charging event measured locally or received from the server 259. The battery aging may be further determined using the present health of the traction battery 124. As a general rule, a lower charging power may be associated with a reduced amount of battery aging whereas a higher charging power may be associated with an increased amount of battery aging. In one example, 75 kW charging power may be associated with almost $0.00 battery aging whereas 125 kW and 150 kW may be associated with $1.00 and $1.25 battery aging in monetary value in a given period of time.

At operation 312, the EVSE 138 determines if the aging value is within the aging threshold specified in the user demand. If the answer is no indicative of the aging associated with one or more candidate charging options being unacceptable, the process proceeds to operation 314, and the EVSE 138 reduces the planned charging power and re-determines one or more new charging options. In general, a reduced charging power may lower the heat generated during the charging and therefore reduce the battery aging. If the answer for operation 312 is yes, the process proceeds to operation 316 and the EVSE 138 presents the options to the user to select from. The EVSE 138 may present the options via the HMI controls 266. Additionally or alternatively, the EVSE 138 may output the charging options to the vehicle 112 and/or the mobile device 222 to present to the user. The charging option may include various information associated with each option. For instance, the charging option may be presented to the user including a total price, charging duration and battery aging value associated with each option and ask the user to choose from one of the options. Responsive to receiving a user input indicative of a user selection of one of the candidate charging options, the process proceeds to operation 318 and EVSE 138 charges the vehicle based on the selected charging option.

Additionally or alternatively, the EVSE 138 may configured to perform an automated decision making when multiple charging options are available without requiring to present each option to the user. More specifically, the user may predefine a cost threshold that enables the EVSE 138 and/or the vehicle 112 to automatically select one of the qualifying option without making an user input each time the vehicle 112 is connected to the EVSE 138. The cost threshold may take into account not only the price to pay for the charging, but also the battery aging cost and an additional time to wait for the charging cost by the user. For instance, the total cost for each charging option may be determined using the following equation:

$${Cost}_{total} = t * p + {c}_{batt} + u * a$$

The above equation takes three factors into account to evaluate the total cost. The first factor t*p represents the price to pay for the charging for the corresponding option (the power cost for the charge). t denotes the time required to charge the vehicle for the option and p denotes the charging rate (e.g. price per minute) for the option. The second factor c_{batt} represents monetary devaluation of the traction battery 124 associated with the charging option (the traction battery aging cost). The third factor u*a represents a time cost associated for the user to wait for the vehicle to complete the charge. The time cost may be presented and evaluated in various manners. In the present example, the time cost may be evaluated in the form of additional time over the fastest charging option which is used as a reference. u denotes a user defined value ($20 per hour) representative of the user's timing rate and a denotes an additional time of the corresponding option as compared with the fastest charging time. For instance, if the EVSE 138 determines the fastest charging time is 30 minutes and the present option requires 45 minutes to complete, the additional 15 minutes will result in a $5 time cost (i.e. $20 per hour*0.25 hour). With the total cost for each option determined, the EVSE 138 may be configured to automatically select the charging option with the lowest cost without requiring a user input each time.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors, for example, may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a traction battery; and
a controller programmed to,
responsive to a request to DC fast charge a traction battery at a charge station that offers a plurality of DC fast charge rates each with a cost per unit time that increases as the rate increases, generate output, only for each of the rates that correspond to an aging parameter for the traction battery that is less than a threshold value, indicating a cost to charge the traction battery at the rate, and
charge the traction battery at a selected one of the rates.

2. The vehicle of claim 1, wherein the controller is further programmed to automatically select one of the rates according to user defined criteria to identify the selected one of the rates.

3. The vehicle of claim 1, wherein the output further indicates a duration to charge the traction battery at the rate.

4. The vehicle of claim 1, wherein the cost includes a portion representing a user's per unit time value.

5. The vehicle of claim 4, wherein the controller is further programmed to receive input defining the user's per unit time value.

6. The vehicle of claim 1, wherein the cost includes a portion representing a product of a user's per unit time value and a difference between a charge duration at the rate and a charge duration at a maximum of the rates that correspond to the aging parameters that are less than the threshold value.

7. The vehicle of claim 1, wherein the controller is further programmed to receive input defining the threshold value.

8. A method comprising:
after receiving a request to DC fast charge a traction battery at a charge station that offers a plurality of DC fast charge rates each with a cost per unit time that increases as the rate increases, charging the traction battery at one of the rates automatically selected according to a total cost that includes portions representing a power cost for the charge, a user's time cost for the charge, and a traction battery aging cost for the charge such that the total cost is less than a threshold cost.

9. The method of claim 8 further comprising receiving input defining the threshold cost.

10. The method of claim 8, wherein the user's time cost is a product of a user's per unit time value and a duration of the charge.

11. The method of claim 8, wherein the traction battery aging cost is a function of a duration of the charge and the one of the rates.

12. The method of claim 8, responsive to a state of charge of the traction battery exceeding a threshold state of charge, generating output indicating a recommendation to switch to non-DC fast charge.

13. A vehicle control system comprising:
a controller programmed to charge a traction battery at one of a plurality of DC fast charge rates selected such that the one corresponds to an aging parameter for the traction battery, that is based on a duration of the charge, less than a threshold value.

14. The vehicle control system of claim 13, wherein the controller is further programmed to charge at the one selected such that a total cost of the charge is less than a threshold cost and wherein the total cost includes portions representing a power cost for the charge, a user's time cost for the charge, and a traction battery aging cost for the charge.

15. The vehicle of claim 14, wherein the user's time cost is a product of a user's per unit time value and the duration

16. The vehicle of claim 14, wherein the traction battery aging cost is a function of the duration and the one.

17. The vehicle of claim 14, wherein the total cost is user defined.
